(19) United States
(12) Patent Application Publication
(10) Pub. No.: US 2019/0047074 A1
(43) Pub. Date: Feb. 14, 2019

(54) GRIPPING DEVICE AND WELDING DEVICE

(71) Applicant: HONDA MOTOR CO., LTD., Minato-ku, Tokyo (JP)

(72) Inventors: Akihiko Takahashi, Hagagun, Tochigi-ken (JP); Yushi Aoki, Hagagun, Tochigi-ken (JP)

(21) Appl. No.: 16/077,522

(22) PCT Filed: Feb. 10, 2017
(86) PCT No.: PCT/JP2017/004865

§ 371 Date: Aug. 13, 2018

(30) Foreign Application Priority Data
Feb. 15, 2016 (JP) 2016-025641

(51) Int. Cl. B23K 11/11; B23K 26/082; B23K 26/22; B23K 37/04

(52) U.S. Cl. CPC B23K 11/11; B23K 37/04; B23K 26/22; B23K 26/082

(57) ABSTRACT

A gripping device constituting a welding device has a first contactor and a second contactor, which face each other and come in contact with a material to be welded. The first contactor vibrates at a predetermined vibration frequency under the effect of a first vibrator. The second contactor may be configured so as to be vibrated by a second vibrator. In this case, it is preferable that the first contactor and the second contactor are vibrated at different vibrational frequencies. In the abovementioned configuration, the first contactor and the second contactor periodically repeat contact with and separation from the material to be welded. In this state, the gripping device moves in the welding direction and welding is carried out on the material to be welded.

### TECHNICAL FIELD

The present invention relates to a gripping device and a welding device, and more particularly to a gripping device for gripping, for example, an object to be welded as a workpiece, and a welding device provided with the gripping device.

### BACKGROUND ART

Welding has been widely adopted as a technique for joining thin sheet portions of a plurality of members together. That is, thin sheet portions are laid one on top of another to thereby form an overlapping portion, and a part of abutment surfaces of the overlapping portion is melted by, for example, heat. At this time, a welding pool is formed. By removing the heat, the welding pool is cooled and solidified. Consequently, a welded portion is formed. Incidentally, the heat is applied by energizing the overlapping portion or by irradiating the overlapping portion with a laser. The former is a resistance welding, while the latter is a laser welding.

It may be the case that a minute clearance (gap) is unavoidably formed between the abutment surfaces. In order to address such a case, it is often the case that the overlapping portion is gripped in the thickness direction, in particular, when a laser welding is performed. With this gripping, a member arranged on one end side is pressed toward the other end side, while another member arranged on the other end side is pressed toward the one end side. Owing to the gripping, the gap becomes smaller.

Gripping is performed by, for example, a gripping jig having clampers. As the gripping jig of this kind, there is known one described in Japanese Laid-Open Patent Publication No. 2005-111542.

### SUMMARY OF INVENTION

In performing gripping by clampers as described above, in the case of performing a laser welding over a wide area, it is necessary to grip an overlapping portion over the wide area. In this case, a gripping jig accordingly increases in size.

Further, when the shape of a member differs from the shape of the previously-welded member, it is necessary to use another gripping jig that differs in the position of the clampers and the like. That is, different kinds of gripping jigs have to be prepared in advance depending on the shapes or the like of the members.

For the above reasons, a problem occurs that the facility investment required for the gripping jigs increases. Further, it is a troublesome to make replacement for another jig each time one member is changed to another having a different shape. In addition, this results in the increased number of processing steps and hence the prolonged working hours.

A main object of the present invention is to provide a gripping device capable of realizing a reduction in facility investment because of being excellent in general versatility.

Another object of the present invention is to provide a gripping device in which it is possible to eliminate the need to replace the gripping device when gripping an object to be welded that differs in shape from a previously-gripped workpiece.

A further object of the present invention is to provide a welding device having the aforementioned gripping device.

According to one aspect of the present invention, there is provided a gripping device provided on a moving unit, the gripping device having a first contact element and a second contact element which are configured to grip a workpiece by abutting against the workpiece at positions facing each other, the gripping device further including:

a vibrator configured to vibrate one of the first contact element and the second contact element in a direction to abut against or to be separated from the workpiece,

wherein another contact element of the first contact element and the second contact element, and the one contact element vibrated by the vibrator are moved by the moving unit along a surface of the workpiece while gripping the workpiece.

With this configuration, at least one of the first contact element and the second contact element abuts against or moves away from the workpiece together by vibration. Such abutment causes a load to be applied to the workpiece, and consequently the workpiece is gripped by the first contact element and the second contact element. Accordingly, in a case where the workpiece is a laminated body, a gap between abutment surfaces in the workpiece is decreased.

Then, while the first contact element or the second contact element is separated from the workpiece, the load applied to the workpiece becomes minimum. Thus, when the first contact element and the second contact element are moved along the surface of the workpiece relatively, the friction resistance between the first contact element, the second contact element and the workpiece is accordingly minimum. Thus, even when the first contact element and the second contact element are in a closed state and grip the workpiece therebetween, it is easy for the gripping device to relatively move along the surface of the workpiece.

On the other hand, the time period during which the first contact element and the second contact element are separate away from the object to be welded is significantly short, and more specifically is shorter than 1 second. Accordingly, even in the state that one or both of the first contact element and the second contact element are vibrating, the first contact element and the second contact element frequently abut against the workpiece. Thus, the workpiece is continuously gripped.

From the above reasons, by adopting the aforementioned configuration, it is possible to move the first contact element and the second contact element relatively along a surface of the workpiece while the gripping state of the workpiece by the first contact element and the second contact element is maintained, in other words, while the gripping position by the first contact element and the second contact element is changed.

In addition, it is possible to easily change the moving path of the first contact element and the second contact element by changing the moving direction of the gripping device by the moving unit. Accordingly, for example, when predetermined portions of workpieces differing in shape are to be gripped in succession, it is possible to set gripping positions depending on the shapes of the workpieces. That is, the gripping device is excellent in general versatility.

Accordingly, it is unnecessary to prepare plural types of gripping devices in correspondence to the shapes of workpieces. Thus, it is possible to achieve a reduction in facility investment. Furthermore, it is unnecessary to change gripping devices each time the workpiece is changed to another workpiece having a different shape. Thus, troublesome exchanging or replacing works become unnecessary, and hence an increase in the number of processes is avoided.

Both of the first contact element and the second contact element may be vibrated. In this case, another vibrator may be further provided for vibrating the other one of the first contact element and the second contact element in a direction to abut against or to be separated from the workpiece.

In a case where both of the first contact element and the second contact element are vibrated, it is preferable to set the vibrational frequencies to be mutually different from each other. The reason is as follows. That is, in a case of the same vibrational frequencies, the first contact element and the second contact element simultaneously abut against the workpiece, and thus it is not easy to reduce the friction resistance in comparison with the case where the vibrational frequencies are different from each other.

Furthermore, it is preferable that the first contact element and the second contact element be installed on respective ends of an arm member having a substantially U-shape. In this case, it is easy to interpose the workpiece between the first contact element and the second contact element.

Incidentally, in a case where the first contact element or the second contact element is displaced in a direction toward or away from the workpiece under the operation of a displacing unit, a servomotor is used as a preferable example of the displacing unit. With the servomotor, it is possible to perform accurate control.

Alternatively, the displacing unit may be constituted by a pneumatic cylinder. In this case, for example, it is possible to absorb, with the pneumatic cylinder, an impact load which is exerted when the first contact element or the second contact element being vibrated abuts against the workpiece.

Furthermore, it is preferable that the first contact element or the second contact element be vibrated at such a vibrational frequency that the first contact element and the second contact element simultaneously abut against the workpiece at least once while being moved by a contact width over which the first contact element or the second contact element contacts the workpiece. Since within the time period of movement by the contact width, the first contact element and the second contact element simultaneously abut against the workpiece, it is possible to continuously grip the workpiece.

Furthermore, the first contact element and the second contact element preferably each have a spherical surface. In this case, even in a case that the first contact element or the second contact element is brought into contact with the workpiece in a direction inclined from a direction perpendicular to a surface of the workpiece, since the surfaces of the first contact element and the second contact element are spherical surfaces, the spherical surfaces are each placed into abutment against the workpiece over a predetermined contact width. That is, it is possible to ensure a substantially equivalent abutment area each time the gripping operation is performed.

In either case, it is preferable that vibrational frequencies of both of the first contact element and the second contact element be set to be higher than the natural vibration frequency of the workpiece. In this case, the vibrational frequencies of the first contact element and the second contact element are each higher than the resonance point of the workpiece. Accordingly, it is possible to prevent the workpiece from being vibrated uselessly.

According to another aspect of the present invention, there is provided a welding device which includes:

a gripping device configured as described above;

a moving unit configured to move the gripping device; and

a welding unit configured to perform welding on the workpiece gripped by the gripping device;

wherein the welding unit performs welding on the workpiece while at least one of the first contact element and the second contact element is vibrated by the vibrator and the contact elements are moved by the moving unit along a surface of the workpiece.

With the above configuration, it is possible to perform welding while gripping only a portion of the workpiece that is adjacent to the welded portion. In addition, after the welding of a predetermined portion is finished, it is easy to weld the next portion by moving the gripping device and the welding unit. Accordingly, it is possible to achieve the downsizing of the gripping device and hence the welding device. It is also possible to shorten the operation time from start of the welding until completion thereof.

A preferred example of the welding unit includes a laser irradiation mechanism. In this case, the welding device is a laser welding device.

Although the laser irradiation mechanism may be provided on a moving unit other than the moving unit for moving the gripping device, the laser irradiation mechanism more preferably should be provided on the moving unit for moving the gripping device or on the gripping device. In this case, the moving unit for the gripping device can be used also as a moving unit for the laser irradiation mechanism, and thus it is possible to realize further downsizing of the welding device.

The laser irradiation position by the laser irradiation mechanism is preferably shifted from an abutment position at which the first contact element and the second contact element abut against the workpiece. In this case, the laser light is not intercepted by the first contact element and the second contact element. Accordingly, the laser light easily falls on the workpiece. As a result, welding is easily performed.

According to the present invention, since at least one of the first contact element and the second contact element is vibrated, the gripping device is capable of easily moving in spite of gripping the workpiece. Therefore, it is easy to continuously change a position where the gap is to be decreased, by moving the first contact element and the second contact element performing the gripping.

Accordingly, for example, in the case of performing welding on the workpiece, it is possible to decrease the gap only in the vicinity of the welding position. Therefore, it is unnecessary to hold the workpiece at a plurality of positions. This makes it possible to realize the downsizing of the gripping device.

Furthermore, the gripping device is excellent in general versatility. This is because it is possible to suitably change the moving direction of the first contact element and the second contact element. Accordingly, it is possible to realize a reduction in facility investment. In addition, since it is unnecessary to change the gripping devices each time the workpiece is changed to another one having a different shape, troublesome changing or replacing works are unnecessary. In addition, it is possible to avoid an increase in the number of process steps.

### BRIEF DESCRIPTION OF DRAWINGS

FIG. 1 is a schematic side view of main components of a welding device according to an embodiment of the present invention;

FIG. 2 is a schematic sectional view of main components showing in an enlarged scale a first contact element of the welding device, and the vicinity thereof;

FIG. 3A is an explanatory view showing an irradiation position of laser light from a laser irradiation mechanism as viewed in a welding direction, and FIG. 3B is an explanatory view showing the irradiation position as viewed in a direction perpendicular to the welding direction; and

FIG. 4 is a waveform diagram showing vibration cycles of the first contact element and a second contact element.

### DESCRIPTION OF EMBODIMENT

Hereinafter, with reference to the accompanying drawings, a gripping device according to the present invention will be described in detail based on a preferred embodiment in connection with a welding device having the gripping device.

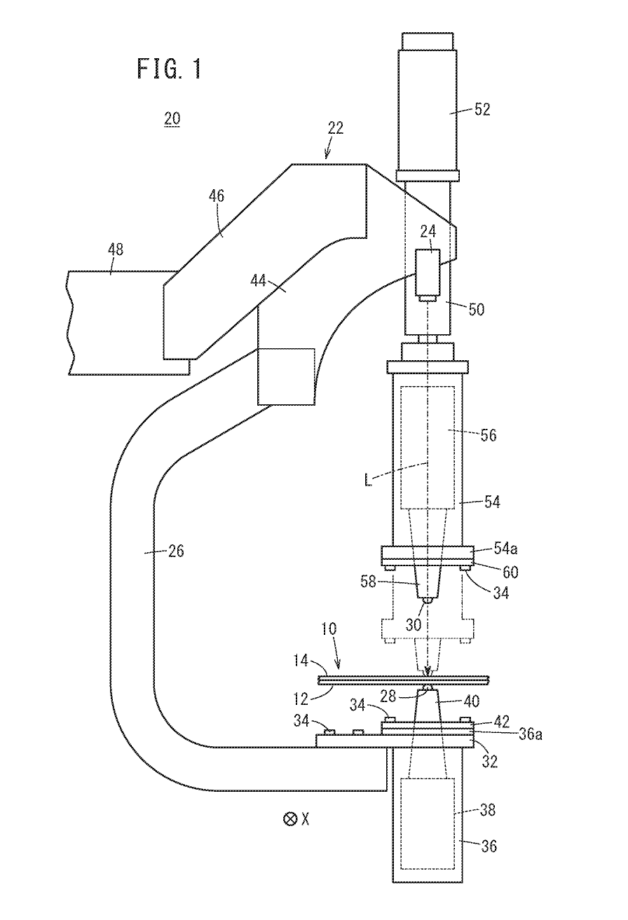

In the present embodiment, welding is performed on an object to be welded (workpiece) 10 shown in FIG. 1. Here, the object to be welded 10 is a laminated body formed by laminating a first thin steel sheet 12 and a second thin steel sheet 14 having the same area as the first thin steel sheet 12 such that the entire lower end surface of the second thin steel sheet 14 is in abutment against the entire upper end surface of the first thin steel sheet 12. That is, in this case, the whole of the object to be welded 10 corresponds to the overlapping portion. Incidentally, in the figures, symbol “X” represents a direction in which welding is performed (i.e., welding direction) and, in FIG. 1, the direction X is directed from the front side to the back side of the drawing sheet.

Next, a welding device 20 according to the present invention will be described. FIG. 1 is a schematic side view of main components of the welding device 20 according to the present embodiment. The welding device 20 is configured to include a gripping device 22, a laser irradiation mechanism 24 as a welding unit, and a robot (not shown) as a moving unit.

First, the gripping device 22 will be described. The gripping device 22 has an arm member 26 having a substantially U-shape, and also has a first contactor or contact element 28 and a second contactor or contact element 30 which are provided on the arm member 26. The arm member 26 is bifurcated so as to have two end portions, and one end portion faces downward while the other end portion faces upward. The first contact element 28 is disposed at one of the end portions that is on the lower side (i.e., a lower end), while the second contact element 30 is disposed at the other end portion on the upper side (i.e., an upper end). Incidentally, the lower end portion of the arm member 26 is slightly longer than the upper end portion thereof.

A holding member 32 of a flat plate shape is connected to the lower end of the arm member 26 by bolts 34 so as to protrude in the horizontal direction. The holding member 32 is formed with a through hole (not shown) extending in the thickness direction. A first holder 36 of a bottomed cylindrical body is passed through the through hole. The first holder 36 is caught in the through hole by a lower end surface of a first flange portion 36a being held in abutment on an upper end surface of the holding member 32. With this catching, the first holder 36 is prevented from dropping out of the through hole.

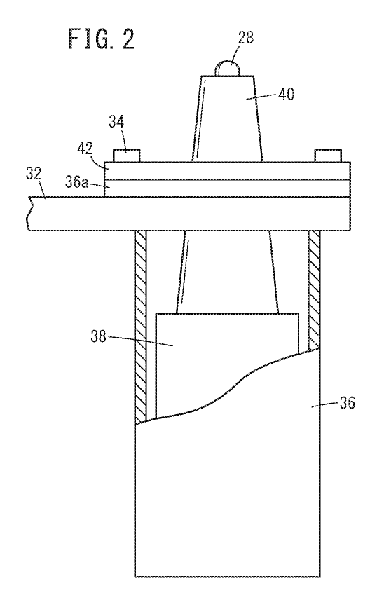

As schematically shown in FIG. 2, a first vibrator 38 comprising, for example, a Langevin transducer is accommodated in the first holder 36. Further, a first cone 40 having a frusto-conical shape is interposed between the first vibrator 38 and the first contact element 28. The first contact element 28 is provided at an upper end of the first cone 40 protruding from the first holder 36. Accordingly, the first contact element 28 vibrates together with the first cone 40 under the operation of the first vibrator 38.

A first cap member 42 is superposed on the first flange portion 36a to cover an upper portion of the first holder 36. Needless to say, a through hole through which the first cone 40 passes is formed in the first cap member 42. Bolt insertion holes are formed in both of the first cap member 42 and the first flange portion 36a, and bolts 34 passed through these insertion holes are screw-engaged with bolt holes formed in the holding member 32. As a result, the first holder 36 is held by the arm member 26 through the holding member 32. Incidentally, none of the through hole, the bolt insertion holes and the bolt holes are illustrated.

A first bracket 44 is supported on the upper end of the arm member 26 (refer to FIG. 1) to extend further upward in the vertical direction. An end arm 48 of the aforementioned robot is connected to a wide upper end of the first bracket 44 through a second bracket 46.

An end portion of the first bracket 44 on an opening side of the U-shape shown in FIG. 1 slightly protrudes. Thus, the end portion is positioned substantially in alignment with the first contact element 28.

A tube 50 is connected to the end portion on the opening side of the U-shape of the first bracket 44 so as to extend in the vertical direction. A servomotor 52 is installed on an upper side of the tube 50. A ball screw shaft of a ball screw is connected to a rotary shaft of the servomotor 52. Furthermore, a second holder 54 is held on a nut of the ball screw through an elastic member such as a spring or the like. Since the rotary shaft of the servomotor 52, the ball screw (ball screw shaft and nut) and the elastic member are accommodated in the tube 50, these elements are not illustrated in FIG. 1.

A second vibrator 56 comprising, for example, a Langevin transducer is accommodated in the second holder 54. Further, a second cone 58 having a frusto-conical shape is interposed between the second vibrator 56 and the second contact element 30. A lower end of the second cone 58 protrudes from the second holder 54, and the second contact element 30 is provided on the lower end of the second cone 58. That is, the second contact element 30 vibrates together with the second cone 58 under the operation of the second vibrator 56. The second contact element 30 is separated away from the first contact element 28 at a predetermined distance in a face-to-face manner.

The second holder 54 has a second flange portion 54a. The second flange portion 54a is covered with a second cap member 60, and the second cap member 60 is connected to the second flange portion 54a by bolts 34. Needless to say, the second cap member 60 is formed with a through hole enabling the second cone 58 to pass therethrough.

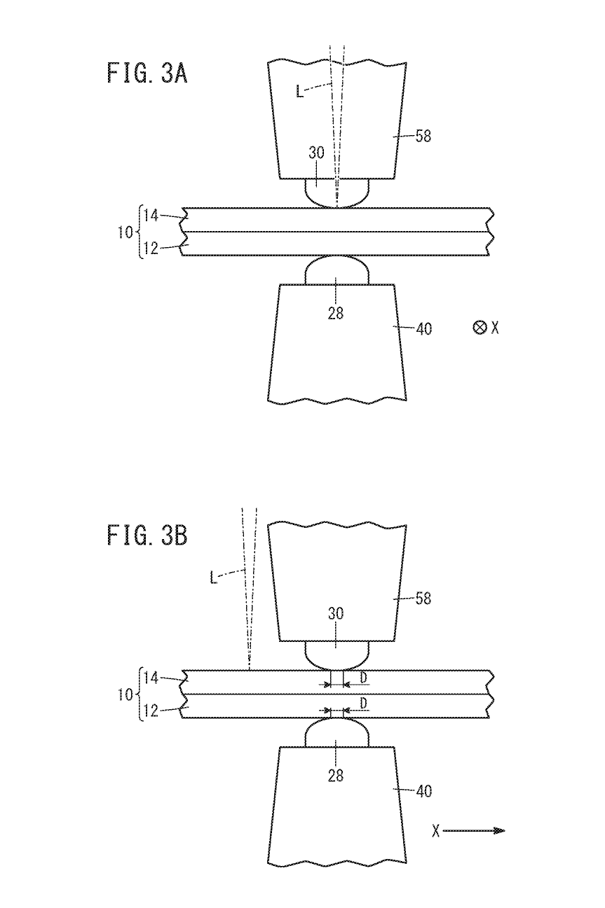

FIG. 3A and FIG. 3B show in an enlarged scale a state that the first contact element 28 is in abutment against the lower end surface of the first thin steel sheet 12 while the second contact element 30 is in abutment against the upper end surface of the second thin steel sheet 14. The first contact element 28 and the second contact element 30 each have a substantially hemispherical distal end having a spherical surface, and an equal-diameter cylindrical portion which faces the distal end and the first cone 40 or the second cone 58. The distal ends are substantially identical with each other in diameter and volume. The first contact element 28 and the second contact element 30 are brought into contact respectively with the first thin steel sheet 12 and the second thin steel sheet 14 such that tops or vertexes of their spherical surfaces of the contact elements 28, 30 face each other across the steel sheets. The first contact element 28 and the second contact element 30 contact respectively the first thin steel sheet 12 and the second thin steel sheet 14 over an area having a contact width D in the welding direction X (refer to FIG. 3B). The contact width D is about 1 mm.

In this state, the first contact element 28 and the second contact element 30 are vibrated under the respective operations of the first vibrator 38 and the second vibrator 56. That is, the first contact element 28 and the second contact element 30 are slightly displaced periodically in a direction toward and away from the first thin steel sheet 12 and the second thin steel sheet 14. Therefore, the first contact element 28 and the second contact element 30 alternate abutment and separation with respect to the first thin steel sheet 12 and the second thin steel sheet 14. The vibration direction of the first contact element 28 and the second contact element 30 is substantially perpendicular to a forward-moving direction of the first contact element 28 and the second contact element 30 (i.e., the direction perpendicular to the surface of the drawing sheet of FIG. 1).

Vibrational frequencies of the first contact element 28 and the second contact element 30 are both set to be higher than the natural vibration frequency of the object to be welded 10 (i.e., the first thin steel sheet 12 and the second thin steel sheet 14). Further, the vibrational frequencies of the first contact element 28 and the second contact element 30 are made to differ mutually. These respects will be described later.

The laser irradiation mechanism 24 serving as a welding unit is supported on the first bracket 44 at the front side in the drawing sheet of FIG. 1. In other words, the laser irradiation mechanism 24 is provided on the gripping device 22. The laser irradiation mechanism 24 irradiates the second thin steel sheet 14 with laser light L from above the object to be welded 10. By the irradiation with laser light, the first thin steel sheet 12 and the second thin steel sheet 14 are welded to each other at their abutment interface. That is, in this case, the welding device 20 is a laser welding device.

The laser irradiation mechanism 24 is disposed at a substantially side portion of the tube 50. Therefore, as shown in FIG. 3A, the laser light L radiated from the laser irradiation mechanism 24 falls on a portion of the second thin steel sheet 14 that is adjacent to a position (hereinafter, this position will be called “abutment position”) at which the first contact element 28 and the second contact element 30 abut respectively against the first thin steel sheet 12 and the second thin steel sheet 14 while facing each other across the steel sheets.

Further, the laser irradiation mechanism 24 is positioned on the front side relative to the first holder 36 and the second holder 54 in the drawing sheet of FIG. 1. Thus, as shown in FIG. 3B, the incident position of the laser light L is shifted from the abutment position in a direction opposite to the welding direction X, more specifically to the forward-moving direction of the first contact element 28 and the second contact element 30.

The gripping device 22 and the welding device 20 according to the present embodiment are basically constructed as above. Next, the operation and effects will be described in connection with the operation of the welding device 20. Incidentally, the operation described below will be automatically performed under the control operation of a control circuit (not shown).

When a laser welding is performed on the object to be welded 10, the lower end surface of the second thin steel sheet 14 is brought into abutment on the upper end surface of the first thin steel sheet 12 (in other words, the second thin steel sheet 14 is superposed on the first thin steel sheet 12), whereby the object to be welded 10 is formed as a laminated body. Thereafter, the gripping device 22 is moved by a suitable operation of the robot, and the end arm 48 of the robot approaches the object to be welded 10. At this time, the second contact element 30 is located at the top dead center. Accordingly, the first contact element 28 and the second contact element 30 are in a so-called open state. Then, the object to be welded 10 is inserted between the first contact element 28 and the second contact element 30 which are in the open state.

At the time of this insertion or after this insertion, the spherical surface of the first contact element 28 is brought into abutment against the lower end surface of the first thin steel sheet 12. Because the arm member 26 provided with the first contact element 28 and the second contact element 30 has a substantially U-shape, the object to be welded 10 is easily inserted between the first contact element 28 and the second contact element 30, and it is easy to bring the spherical surface of the first contact element 28 into abutment against the lower end surface of the first thin steel sheet 12. Incidentally, the contact width D of the first contact element 28 in the welding direction X is about 1 mm as described above.

Next, the servomotor 52 is energized to thereby start rotation of the rotary shaft. Accordingly, the ball screw shaft also rotates, and then the nut and the elastic member are lowered in the tube 50. As a result, the second holder 54 is displaced to come close to the second thin steel sheet 14. Thus, as shown by the imaginary line in FIG. 1, the first contact element 28 and the second contact element 30 are brought into a closed state, and then the spherical surface of the second contact element 30 is in abutment against the upper end surface of the second thin steel sheet 14. That is, the object to be welded 10 is gripped by the first contact element 28 and the second contact element 30.

With this gripping, a load is applied to the object to be welded 10. That is, the first thin steel sheet 12 is pressed toward the second thin steel sheet 14, while the second thin steel sheet 14 is pressed toward the first thin steel sheet 12. Accordingly, in a case where a gap exists between the upper end surface of the first thin steel sheet 12 and the lower end surface of the second thin steel sheet 14, the gap is reduced as much as possible.

Subsequently, the first vibrator 38 and the second vibrator 56 are energized. Thus, the first contact element 28 is vibrated in a direction toward (abutment) or away from the first thin steel sheet 12, while the second contact element 30 is vibrated in a direction toward (abutment) or away from the second thin steel sheet 14.

As described above, the vibrational frequencies of the first contact element 28 and the second contact element 30 are each set to be higher than the natural vibration frequency of the object to be welded 10. In other words, in this case, the vibrational frequencies of the first contact element 28 and the second contact element 30 are higher than the resonance point of the object to be welded 10. Accordingly, the object to be welded 10 is prevented from unnecessarily vibrating.

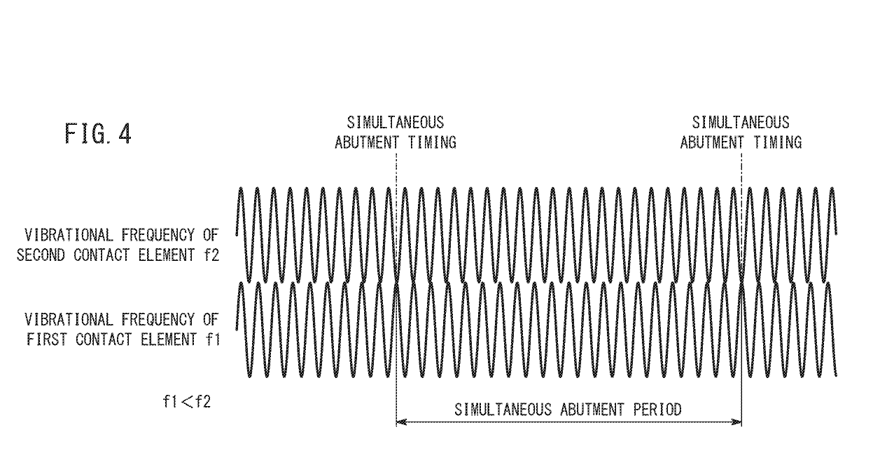

Here, FIG. 4 shows vibration cycles of the first contact element 28 and the second contact element 30. In FIG. 4, the upper waveform is of the second contact element 30, while the lower waveform is of the first contact element 28. When the vibrational frequencies of the first contact element 28 and the second contact element 30 are denoted respectively by f1 and f2, the relationship of f1≠f2 holds as mentioned above. Thus, a timing at which the second contact element 30 abuts against the second thin steel sheet 14 simultaneously while the first contact element 28 abutting against the first thin steel sheet 12, that is, a timing at which the both waveforms contact each other in FIG. 4 (i.e., simultaneous abutment timing), occurs only with a predetermined period or at a predetermined frequency.

Here, the “simultaneous abutment timing” means a timing at which the waveform of the first contact element 28 and the waveform of the second contact element 30 come closest to each other. That is, it does not necessarily mean that a tip or crest of the waveform of the first contact element 28 and a tip or trough of the second contact element 30 exactly coincide with each other, but means a timing at which the tips of the waveforms come closest to each other in a period of “1/|f1−f2|”.

Hereinafter, as a matter of convenience, when the period and the frequency of the simultaneous abutment timing are expressed respectively as “simultaneous abutment period” and “simultaneous abutment frequency”, the simultaneous abutment period is the reciprocal of the absolute value of “f1−f2”. That is, the following expression (1) holds.

Simultaneous abutment period=1/|f1−f2| (1)

Further, the simultaneous abutment frequency is the reciprocal of the simultaneous abutment period and is expressed by the following expression (2).

Simultaneous abutment frequency=|f1−f2| (2)

When at least one of the first contact element 28 and the second contact element 30 is separated away from the object to be welded 10, a load imposed on the object to be welded 10 from the first contact element 28 or from the second contact element 30 becomes minimum during scanning of the laser light L, which will be described later. In this case, the friction resistance from the first contact element 28 or the second contact element 30 becomes minimum accordingly. Therefore, even when the first contact element 28 and the second contact element 30 are in a closed state by operation of the ball screw as a displacement unit to thereby grip the object to be welded 10, the gripping device 22 is easily movable under the operation of the robot.

Incidentally, the simultaneous abutment frequency is preferable to be set so that the simultaneous abutment timing occurs at least once while the first contact element 28 and the second contact element 30 are advanced by the contact width D in the welding direction X. As described above, the contact width D in the present embodiment is approximately 1 mm. Accordingly, in a case where the moving speed of the gripping device 22 and the laser irradiation mechanism 24 is, for example, 10 mm/sec, a setting is made that either one of the first contact element 28 and the second contact element 30 is brought into abutment against the first thin steel sheet 12 or the second thin steel sheer 14 every 1/10 seconds. That is, in this case, the simultaneous abutment frequency is set to be equal to or higher than 10 Hz.

Furthermore, the friction resistance decreases as the f1 and the f2 become higher. From the reason described above, it is preferable to set the f1 and the f2 both to high frequencies and to make the difference therebetween small. Suitable frequencies of the f1 and the f2 are equal to or higher than 1 kHz, and it is preferable that the simultaneous abutment frequency is set so that the difference between the f1 and the f2 becomes 1% or less. For example, when the f1 is set to 1.00 kHz, the f2 can be set to 1.01 kHz, 0.99 kHz or the like. Alternatively, when the f1 is set to 20.000 kHz, the f2 can be set to 19.999 kHz or the like. FIG. 4 shows a case of f1<f2.

The simultaneous abutment frequency can be adjusted, for example, by using the first contact element 28 and the second contact element 30 that are of the same type, while using the first cone 40 and the second cone 58 that mutually differ in mass, volume or the like.

The first contact element 28 and the second contact element 30 are vibrated as above, so as to be periodically brought into abutment against or separation from the first thin steel sheet 12 and the second thin steel sheet 14. The vibration load produced at the time of abutment and imposed on the ball screw is absorbed by the elastic member. Further, even if the first contact element 28 and the second contact element 30 are brought into abutment against the first thin steel sheet 12 and the second thin steel sheet 14 in a direction inclined relative to the vertical direction, since the first contact element 28 and the second contact element 30 each have a substantially hemisphere, the spherical surfaces abut against the first thin steel sheet 12 and the second thin steel sheet 14. Therefore, the contact width D can be ensured.

Incidentally, although the first contact element 28 and the second contact element 30 are separated from the object to be welded 10, the time period for such separation is much shorter than 1 second. Moreover, the first contact element 28 and the second contact element 30 are suitably set to have such vibrational frequencies as to simultaneously abut against the object to be welded 10 at least once while being displaced over a range of the contact width D. Accordingly, even when the first contact element 28 and the second contact element 30 are being vibrated, the object to be welded 10 is continuously gripped by the first contact element 28 and the second contact element 30, and hence a state is maintained that the gap is reduced.

In this state, the laser light L is oscillated and radiated from an oscillation circuit of the laser irradiation mechanism 24. The laser light L falls on or is incident on a portion of the upper end surface of the second thin steel sheet 14 that is located adjacent to a site where the gap is reduced, and advances in the thickness direction within the second thin steel sheet 14. Then, the laser light L reaches the abutment interface between the first thin steel sheet 12 and the second thin steel sheet 14, and melts the abutment interface. The melting occurs easily because the gap between the first thin steel sheet 12 and the second thin steel sheet 14 is reduced.

Further, since the laser irradiation position is shifted from the abutment position of the first contact element 28 and the second contact element 30 in a direction opposite to the forward-moving direction (refer to FIG. 3B), the laser light L enters the second thin steel sheet 14 without falling on the first contact element 28 or the second contact element 30.

While performing the laser irradiation and the melting as above, the welding device 20 moves the end arm 48 in the welding direction X set along the surface of the object to be welded 10. The welding direction X is indicated by the arrow X shown in FIG. 3B, and directed into the drawing sheet in FIG. 1 and FIG. 3A.

Since the gripping device 22 follows this movement and then moves in the same direction, the laser irradiation mechanism 24 is moved, that is, scanning operation of the laser light L is performed. As a result, a laser irradiation position changes continuously. That is, the laser light L is moved to another position along the welding direction X. Thus, the melted abutment interface is cooled to thereby become a solid phase. That is, the first thin steel sheet 12 and the second thin steel sheet 14 are welded. By moving the laser irradiation mechanism 24 along the welding direction X, the first thin steel sheet 12 and the second thin steel sheet 14 are continuously welded along the trajectory of the laser light incident position, whereby the first thin steel sheet 12 and the second thin steel sheet 14 are integrated together.

As described above, since the first contact element 28 and the second contact element 30 are vibrated at mutually different vibrational frequencies, a friction resistance between the first contact element 28, the second contact element 30 and the object to be welded 10 during movement of the gripping device 22 is small. Accordingly, the gripping device 22 easily moves along the surface of the object to be welded 10 in the state that the first contact element 28 and the second contact element 30 grip the object to be welded 10 therebetween.

As mentioned above, in the present embodiment, since the first contact element 28 and the second contact element 30 are vibrated at different vibrational frequencies, the gripping device 22 easily moves in spite of gripping the object to be welded 10. Thus, it is easy to continuously change the position where the gap is reduced, by moving the first contact element 28 and the second contact element 30 performing the gripping.

Accordingly, in this case, it is possible to reduce the gap only in the vicinity of a position at which a laser welding is performed, and moreover, such gap reduction is sufficient to perform the laser welding. This is because as described above, it is possible to successively move the abutment position of the first contact element 28 and the second contact element 30. Therefore, it is not necessary to grip the object to be welded 10 at a plurality of positions, and hence it is possible to achieve the downsizing of the gripping device 22.

Further, when the scanning direction of the laser irradiation mechanism 24 is to be changed in order to perform a laser welding on another object to be welded (workpiece) differing in shape from the object to be welded 10, in other words, when the laser welding is to be performed along a welding direction different from the welding direction X shown in FIGS. 1, 3A and 3B, it is only necessary to change the moving direction of the end arm 48 by the operation of the robot. Also in this case, the laser welding can be performed by moving the gripping device 22 with the object to be welded being gripped by the first contact element 28 and the second contact element 30 in the same manner as described above.

Like this, by changing the moving direction of the end arm 48, the gripping device 22 can cope with welding of various workpieces having different shapes. That is, the gripping device 22 is excellent in general versatility. Accordingly, since it is unnecessary to prepare plural different types of gripping devices in correspondence to the shapes of objects to be welded, it is possible to achieve the reduction in facility investment. Furthermore, since it is unnecessary to exchange gripping devices each time the object to be welded is changed to another object having a different shape, cumbersome exchanging works are unnecessary, and in addition, it is possible to avoid an increase in the number of processes.

When operation of the robot (the end arm 48) is stopped, operations of the gripping device 22 and the laser irradiation mechanism 24 are stopped. Then, the laser welding is finished. Thereafter, the rotary shaft of the servomotor 52 is rotated in a direction opposite to the above direction, so that the ball screw shaft rotates in the reverse direction accordingly. Furthermore, the nut and the elastic member are moved upward along the ball screw shaft, whereby the second contact element 30 moves upward together with the second holder 54 and is separated away from the second thin steel sheet 14. That is, the first contact element 28 and the second contact element 30 are placed in the open state.

Thereafter, the end arm 48 operates to retract from the object to be welded 10. Consequently, the object to be welded 10 is released from between the lower end (the first contact element 28) and the upper end (the second contact element 30) of the arm member 26 of the gripping device 22.

The present invention is not particularly limited to the aforementioned embodiment and can be variously modified without departing from the scope of the present invention.

For example, one of the first vibrator 38 and the second vibrator 56 may be omitted, wherein one of the first contact element 28 and the second contact element 30 can be vibrated, while the other cannot be vibrated.

Further, a pneumatic cylinder may be utilized as a displacing unit in substitution for the servomotor 52. In this case, a load imposed when the vibrating second contact element 30 is in abutment against the object to be welded 10 can be absorbed by the pneumatic cylinder. Accordingly, it is unnecessary to provide the elastic member. Incidentally, in a case where a contact element such as the first contact element 28 is attached to the arm member 26, since the arm member 26 itself shows some elasticity, the elastic member such as a spring does not necessarily need to be additionally interposed between the ball screw and the arm member 26. However, the elastic member may be interposed therebetween.

Furthermore, the arm member may be formed in an X-shape by crossing two bar-shaped members. In this case, the bar-shaped members are relatively pivotable about a crossing point between the bar-shaped members, and the first contact element 28 and the second contact element 30 may be provided respectively at the same-side end portions of the bar-shaped members. That is, when the bar-shaped members are pivoted in a direction in which the first contact element 28 and the second contact element 30 approach each other, a closed state is brought about, whereas the bar-shaped members are pivoted in a direction in which the contact elements 28, 30 are separated away from each other, an open state is brought about.

Still furthermore, although, in the present embodiment, the laser irradiation mechanism 24 is attached to the gripping device 22, the laser irradiation mechanism 24 may be provided on another robot which is different from the robot supporting the gripping device 22 on the end arm 48.

In addition, the welding unit is not particularly limited to the laser irradiation mechanism 24, and may be any means as long as it is capable of performing a clamping operation. For example, the welding unit may be a spot welding mechanism.

Yet furthermore, the contact elements may each have a substantially hemispherical portion only.

Further additionally, the gripping device 22 is not particularly limited to one incorporated in the welding device 20, and can be widely used as one for gripping a workpiece other than the object to be welded 10.

What is claim is:

1. A gripping device provided on a moving unit, the gripping device having a first contact element and a second contact element which are configured to grip a workpiece by abutting against the workpiece at positions facing each other; the gripping device further comprising:
a vibrator configured to vibrate one of the first contact element and the second contact element in a direction to abut against or to be separated from the workpiece;
wherein another contact element of the first contact element and the second contact element, and the one contact element vibrated by the vibrator are moved by the moving unit along a surface of the workpiece while gripping the workpiece.

2. The gripping device according to claim 1, further comprising:
another vibrator configured to vibrate the other contact element in a direction to abut against or to be separated from the workpiece.

3. The gripping device according to claim 2, wherein the first contact element and the second contact element are vibrated at mutually different vibrational frequencies.

4. The gripping device according to claim 3, wherein the first contact element or the second contact element is vibrated at a vibrational frequency so that the first contact element and the second contact element simultaneously abut against the workpiece at least once while being moved by a contact width over which the first contact element or the second contact element contacts the workpiece.

5. The gripping device according to claim 1, wherein both vibrational frequencies of the first contact element and the second contact element are higher than a natural vibration frequency of the workpiece.

6. A welding device comprising:
a gripping device having a first contact element and a second contact element which are configured to grip a workpiece by abutting against the workpiece at positions facing each other;
a moving unit configured to move the gripping device; and
a welding unit configured to perform welding on the workpiece gripped by the gripping device;
wherein:
the gripping device includes a vibrator configured to vibrate one of the first contact element and the second contact element in a direction to abut against or to be separated from the workpiece; and
the welding unit performs welding on the workpiece while another contact element of the first contact element and the second contact element, and the one contact element vibrated by the vibrator are moved by the moving unit along a surface of the workpiece in a state of gripping the workpiece.

7. The welding device according to claim 6, wherein:
the gripping device further includes another vibrator configured to vibrate the other contact element in a direction to abut against or to be separated from the workpiece.

8. The welding device according to claim 7, wherein the first contact element and the second contact element are vibrated at mutually different vibrational frequencies.

9. The welding device according to claim 8, wherein the first contact element or the second contact element is vibrated at a frequency so that the first contact element and the second contact element simultaneously abut against the workpiece at least once while being moved by a contact width over which the first contact element or the second contact element contacts the workpiece.

10. The welding device according to claim 6, wherein the welding unit is a laser irradiation mechanism.

11. The welding device according to claim 10, wherein the laser irradiation mechanism is provided on the moving unit or the gripping device.

12. The welding device according to claim 11, wherein a laser irradiation position by the laser irradiation mechanism is shifted from a position at which the first contact element and the second contact element abut against the workpiece.
